(19) United States
(12) Patent Application Publication
(10) Pub. No.: US 2026/0058735 A1
(43) Pub. Date: Feb. 26, 2026

(54) Method and system for providing a connection diagram between a test device and a device under test

(71) Applicant: Rohde & Schwarz GmbH & Co. KG, Munchen (DE)

(72) Inventors: Byron Steffan, München (DE); Mustafe Dobra, München (DE)

(21) Appl. No.: 19/095,817

(22) Filed: Mar. 31, 2025

Related U.S. Application Data
(63) Continuation-in-part of application No. 18/812,023, filed on Aug. 22, 2024.

(51) Int. Cl. H04B 17/00

(52) U.S. Cl. CPC H04B 17/0085

(57) ABSTRACT

A test method and test system for providing a connection diagram (CDIA) and/or a connection list between a test device and a device under test wherein the test device has a plurality of connectors with different characteristics and the device under test has a plurality of antennas, wherein the connection diagram (CDIA) and/or connection list is calculated by a processor automatically on the basis of a Band-Centric DUT Connector Configuration indicating a mapping between frequency bands and a set of device under test connectors and/or antennas in transmission (TX) and reception (RX) direction.

### CROSS-REFERENCE TO RELATED APPLICATIONS

This Application is a Continuation in Part application of U.S. application Ser. No. 18/812,023 filed on Aug. 22, 2024, the content of which is incorporated herein by reference in its entirety.

### TECHNICAL FIELD

The invention relates to a method and a test system for providing automatically a connection diagram CDIA between a test device and a device under test and in particular to derive automatically an optimal connection diagram based on a given Band-Centric DUT connector configuration.

### TECHNICAL BACKGROUND

Modern communication devices using new telecommunication standards for transmitting data typically use Multiple Input Multiple Output (MIMO) techniques in order to multiply the capacity of a communication link. Accordingly, the communication devices used for MIMO communication typically comprise multiple transmission antennas and multiple receiving antennas.

For configuring the antenna frequency band relation of the respective communication device, a user has to consider a data sheet of the communication device in order to configure the communication device in an appropriate manner, particularly the relation of the respective antennas with respect to the frequency bands supported by the device under test. The frequency bands may relate to at least one specific telecommunication standard or telecommunication technique.

Measurement systems for testing properties of electronic devices under test (DUTs) are known. Usually, there are two different types of measurements that are performed on the device under test. In a first type of measurements, the device under test is subjected to an external stimulus signal and the response of the device under test (tethered or wireless) is measured. In a second type of measurement, the device under test generates a tethered or wireless signal, which is received and analyzed by the measurement system. An analysis circuit can analyze the response signal of the device under test DUT and/or the signal generated by the device under test DUT in order to assess whether the device under DUT test is working correctly.

Before testing can be performed cabling of the device under test to the test equipment of the test system has to be performed. Because of the different types of devices under test and the wide variety of applicable test scenarios the cabling can become cumbersome and error prone. Moreover often re-cabling becomes necessary when different test scenarios are applied to a device under test. This leads to a significant increase of the required testing time and/or to a diminishment of the testing performance when testing a plurality of devices under test. Against this background there is a need to provide a method and system that facilitates cabling of a device und test to a test device of a test system and increases the efficiency of testing.

### SUMMARY

The invention provides according to a first aspect a method for providing a connection diagram between a test device and a device under test, DUT, wherein said test device has a plurality of connectors with different characteristics and said device under test has a plurality of antennas, wherein the connection diagram is calculated automatically on the basis of a given Band-Centric DUT Connector Configuration indicating a mapping between frequency bands and a set of DUT connectors and/or antennas in transmission (TX) and reception (RX) direction.

The method for providing a connection diagram between a test device and a device under test, DUT, has the advantage that a user does not need to know the internal system behavior. Further, the method does not need to be extended for every new DUT that is being tested on the test equipment. By scaling this, the likelihood that a re-cabling can be avoided is increased.

In a possible embodiment of the method for providing a connection diagram between a test device and a device under test according the characteristics of the connectors of the test device comprise specific frequency bands, power levels, power ranges and data transfer directions.

In a possible embodiment of the method for providing a connection diagram between a test device and a device under test the connection diagram is calculated automatically by an agent to fulfill predefined optimization criteria.

In a possible embodiment of the method for providing a connection diagram between a test device and a device under test multiple connection diagrams and/or connection lists are calculated by different optimization algorithms run by agents and supplied to a connection diagram rating engine which selects automatically an optimal connection diagram having a highest calculated rating based on information stored in an information database.

In a possible embodiment of the method for providing a connection diagram between a test device and a device under test a connection diagram is calculated by an optimization algorithm run by the agent to determine an optimum cabling between the test device and the device under test, DUT, providing a high number of test scenarios and minimizing the likelihood for requiring a re-cabling.

In a possible embodiment of the method for providing a connection diagram between a test device and a device under test the optimization algorithm run by the agent comprises a mixed integer linear program (MILP).

In a possible embodiment of the method for providing a connection diagram between a test device and a device under test the mixed integer linear program (MILP) takes into account a cell combination list comprising cells with frequency bands to be tested for determining the optimum cabling between the test device and the device under test.

In a possible embodiment of the method for providing a connection diagram between a test device and a device under test the mixed integer linear program (MILP) takes into account a maximum use of hardware within the test device and/or splitters and combiners provided outside the test device as optimization criteria for determining the optimum cabling between the test device and the device under test.

In a possible embodiment of the method for providing a connection diagram between a test device and a device under test the connection diagram is calculated by the agent on the basis of a trained data model.

In a possible embodiment of the method for providing a connection diagram between a test device and a device under test the data model of the agent is trained by reinforcement learning.

In a possible embodiment of the method for providing a connection diagram between a test device and a device under test the data model comprises a deep learning model trained in a training phase on the basis of training data.

A test system for providing a connection diagram between a test device of said test system and a device under test, DUT, wherein said test device has a plurality of connectors with different characteristics and said device under test, DUT, has a plurality of antennas, wherein the connection diagram is calculated by a processor of the test system automatically on the basis of a given Band-Centric DUT Connector Configuration indicating a mapping between frequency bands and a set of DUT connectors and/or antennas in transmission (TX) and reception (RX) direction.

In a possible embodiment of the test system for providing a connection diagram between a test device of said test system and a device under test the test system comprises a memory adapted to store a band-centric device under test, DUT, connector configuration of a device under test, DUT; a processor adapted to process the band-centric device under test, DUT, connector configuration of the device under test, DUT, to derive a connection diagram between the test device and the device under test, DUT; and an interface adapted to output the connection diagram derived by the processor.

In a possible embodiment of the test system for providing a connection diagram between a test device of said test system and a device under test the calculated connection diagram is output via a user interface of the test system as a cabling suggestion to a user.

In a possible embodiment of the test system for providing a connection diagram between a test device of said test system and a device under test the test device of the test system comprises test device interfaces including RF Ports used for transmitting and receiving RF signals, control interfaces used for controlling the device under test, DUT, and data interfaces provided for data communication with the device under test, DUT.

In a possible embodiment of the test system for providing a connection diagram between a test device of said test system and a device under test the device under test, DUT, comprises device under test, DUT, interfaces including antenna ports for RF signal input and RF signal output, control ports and data ports for data communication with the test device.

In a possible embodiment of the test system for providing a connection diagram between a test device of said test system and a device under test the test device interfaces of the test device and the device under test interfaces of the device under test, DUT, are connectable with each other by means of cables according to the calculated connection diagram.

In a possible embodiment of the test system for providing a connection diagram between a test device of said test system and a device under test the calculated connection diagram indicates a cabling that minimizes the need for re-cabling when performing several different tests on a single device under test, DUT, and/or when performing several different tests sequentially on several devices under test, DUTs, of a group of devices under test, DUT, one device under test, DUT, after the other.

In a possible embodiment of the test system for providing a connection diagram between a test device of said test system and a device under test the device under test, DUT, comprises a user equipment, UE, in particular a mobile phone.

The invention provides according to a further aspect a software tool for providing a connection diagram between a test device and a device under test, wherein said test device has a plurality of connectors with different characteristics and said device under test, DUT, has a plurality of antennas, wherein the software tool is adapted to calculate automatically the connection diagram on the basis of a Band-Centric-DUT-connector configuration indicating a mapping between frequency bands and a set of DUT connectors and/or antennas in a transmission direction and a reception direction.

### BRIEF DESCRIPTION OF FIGURES

FIG. 1 shows a block diagram for illustrating a possible exemplary embodiment of a test system according to an aspect of the present invention;

FIG. 2 shows a flowchart of a possible exemplary embodiment of a method for providing a connection diagram between a test device of said test system and a device under test, DUT, according to a further aspect of the present invention;

FIG. 3 shows schematically a possible exemplary embodiment of a method for providing a connection diagram between a test device of said test system and a device under test, DUT, according to the present invention

FIG. 4 shows an example of an antenna matrix in a band centric view for the embodiment illustrated in FIG. 3 to demonstrate the operation of a method for providing a connection diagram between a test device of said test system and a device under test, DUT;

FIG. 5 shows schematically a further possible exemplary embodiment of a method for providing a connection diagram between a test device of said test system and a device under test, DUT, according to the present invention;

FIG. 6 shows schematically a further possible exemplary embodiment of a method for providing a connection diagram between a test device of said test system and a device under test, DUT, according to the present invention;

### DETAILED DESCRIPTION OF EMBODIMENTS

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

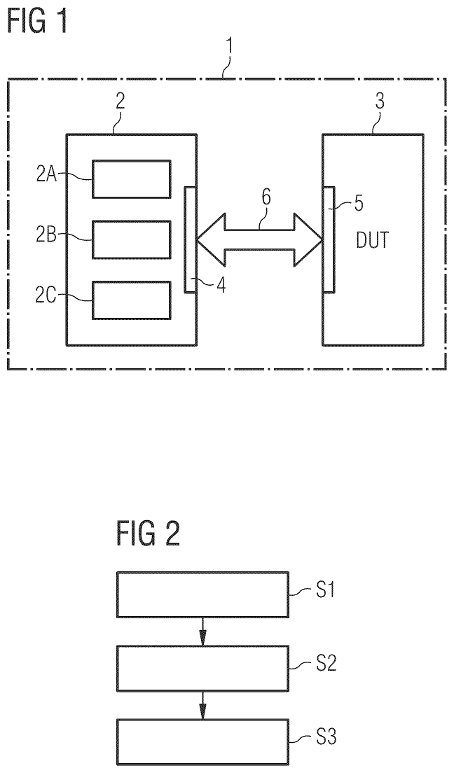

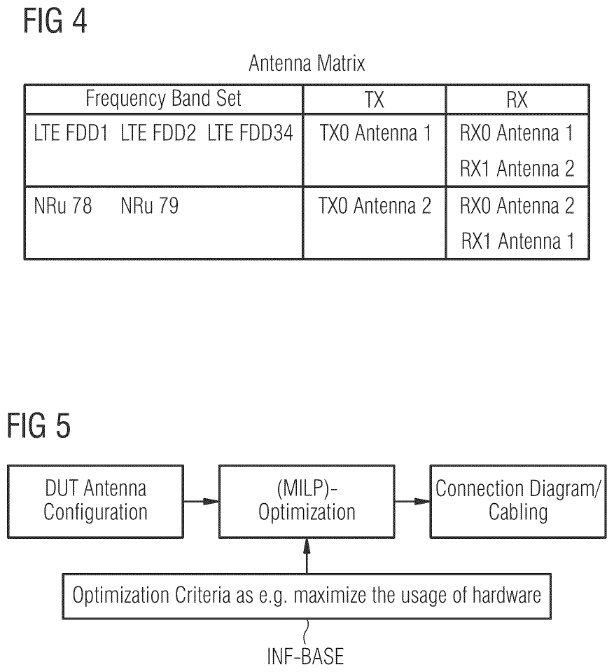

As can be seen in the block diagram of FIG. 1 the invention provides in a possible embodiment a test system 1 for providing a connection diagram between a test device 2 of said test system 1 and a device under test (DUT) 2 The test device 2 has a plurality of connectors with different characteristics and the device under test 3 has a plurality of antennas, wherein the connection diagram is calculated by a processor of the test system 1 automatically on the basis of a given Band-Centric DUT Connector Configuration indicating a mapping between frequency bands FBs and a set of DUT connectors and/or antennas in transmission (TX) and reception (RX) direction. FIG. 4 shows an example of an antenna matrix in a band centric view comprising a mapping of frequency Bands FBs of a frequency band set and DUT connectors in transmission (TX) and reception (RX) direction.

FIG. 1 shows the block diagram of a test-system 1 according to example embodiments of this invention. The test-system 1 comprises a test equipment or test device 2 connected to a device-under-test (DUT) 3. By way of example, the device-under-test 3 is supplied with power from to test-system 1. Furthermore, the device-under-test 3 can receive stimulus signals from the test device 2 of the test-system 1. Signals produced by the device-under-test 2 are received by the test device 2 of the test-system 1. The test-system 1 is further capable of performing communication protocols for testing the performance of the device-under-test 3.

Different frequency bands FBs may relate to a telecommunication standard such as Long-Term Evolution (LTE), 5G, Global System for Mobile Communications (GSM) or Universal Mobile Telecommunications System (UMTS) and so on. Further, the specific frequency bands FBs may also relate to a certain telecommunication technique, for instance Wideband Code Division Multiple Access (WCDMA) techniques typically used in UMTS. Generally, the different antennas of the device under test 3 do not support every frequency band FB supported by the entire device under test 3. Moreover, the different antennas of the device under test 3 may not support every direction, namely the transmitting direction (TX direction) and the receiving direction (RX direction), for the respective frequency band FB.

In a possible embodiment of the test system for providing a connection diagram between a test device 2 of said test system and a device under test 3 the test device 2 has access to a memory 2A which stores a band-centric device under test, DUT, connector configuration of a device under test 3 as illustrated in the example shown in FIG. 4. The test device 2 comprises a processor 2B adapted to process the band-centric device under test, DUT, connector configuration of the device under test 3 to derive automatically a connection diagram CDIA and/or a connection list CLIST between the test device 2 and the device under test 3. The test device 2 can further comprise an interface 2C adapted to output the connection diagram derived by the processor 2B. The processor 2B of the test device 2 may comprise or be one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or the like.

In a possible embodiment of the test system 1 for providing a connection diagram between a test device 2 of said test system 1 and a device under test 3 the calculated connection diagram CDIA is output via a user interface of the test system 1 as a cabling suggestion to a user. The displayed connection diagram CDIA can comprise a connection list and/or a schematic diagram indicating an optimum cabling 6 between the test device interfaces 4 and test interfaces 5 of the device under test 3. The optimum cabling 6 can be a cabling with a minimal likelihood for performing a cumbersome re-cabling for a given test scenario. The calculated connection list can comprise in a possible embodiment a machine readable data format.

The test device 2 may test after the cabling has been performed one or more test devices 3 connected to the test device 2 in parallel. Alternatively the test device 2 may test sequentially a number of devices under test (DUTs) 3 supplied to the test system 1.

The cabling between the test device interfaces 4 and test interfaces 5 of the device under test 3 can be performed by a user manually according to the displayed connection diagram CDIA. In a possible embodiment the cabling between the test device interfaces 4 and test interfaces 5 of the device under test 3 is performed at least partially by actuators controlled by a controller of the test system 1 according to a calculated connection list.

In a possible embodiment of the test system for providing a connection diagram between a test device 2 of said test system 1 and a device under test 3 the test device 3 of the test system 1 comprises test device interfaces 4 including RF Ports used for transmitting and receiving RF signals, control interfaces used for controlling the device under test 3 and data interfaces provided for data communication with the device under test 3.

In a possible embodiment of the test system for providing a connection diagram between a test device 2 of said test system 1 and a device under test 3 the device under test 3 comprises device under test, DUT, interfaces 5 including antenna ports for RF signal input and RF signal output, control ports and data ports for data communication with the test device.

In a possible embodiment of the test system 1 for providing a connection diagram between a test device 2 of said test system 1 and a device under test 3 the test device interfaces 4 of the test device 2 and the device under test interfaces 5 of the device under test 3 are connectable with each other by means of cables 6 according to the calculated connection diagram.

In a possible embodiment of the test system for providing a connection diagram between a test device 2 of said test system 1 and a device under test 3 the calculated connection diagram indicates a cabling that minimizes the need for re-cabling when performing several different tests on a single device under test, 3 and/or when performing several different tests sequentially on several devices under test 3 of a group of devices under test 3 one device under test, DUT, after the other.

In a possible embodiment of the test system for providing a connection diagram between a test device 2 of said test system 1 and a device under test 3 the device under test 3 comprises a user equipment, UE, in particular a mobile phone.

The invention provides according to a further aspect a method for providing a connection diagram between a test device and a device under test, DUT as illustrated schematically in the flow chart of FIG. 2

The test device 2 has a plurality of connectors with different characteristics and said device under test 3 has a plurality of antennas. A connection diagram and/or a connection list is calculated automatically on the basis of a given Band-Centric DUT Connector Configuration indicating a mapping between frequency bands and a set of DUT connectors and/or antennas in transmission (TX) and reception (RX) direction.

The Band-Centric DUT Connector Configuration as illustrated in the example of FIG. 4 indicates a mapping between frequency bands FBs and a set of DUT connectors and/or antennas in transmission (TX) and reception (RX) direction. The Band-Centric DUT Connector Configuration can be read from a memory of the test device 2 or from a data repository of the test system 1 or from a data cloud. Each type of DUT can comprise an associated Band-Centric DUT Connector Configuration. In a possible implementation the test device 2 is adapted to detect the type of the device under test 3 automatically and can retrieve the associated Band-Centric DUT Connector Configuration.

The test device 2 of the test system 1 may also comprise at least one processor 2B that is configured to generate a graphical user interface (GUI) that is displayed on a display unit of a user interface 2C. The graphical user interface allows the user to interact with the test system 1 in order to make settings of the test system 1 and/or to adapt certain settings, for instance the respective assignment of the frequency bands FBs supported with the antennas of the device under test 3.

Furthermore, the at least one interface for the device under test 3 may correspond to an uplink antenna, a downlink antenna, an uplink connector and/or a down-link connector. This substantially depends on the type of connection used for connecting the device under test 3 with the test device 2 of the test system 1.

The method for providing a connection diagram CDIA between a test device 2 and a device under test 3 comprises in the illustrated embodiment of FIG. 2 the following steps.

In a first step S1 a band-centric device under test, DUT, connector configuration of a device under test 3 is provided. The band-centric device under test, DUT, connector configuration of a device under test 3 can be read from a data memory.

In a further step S2 the provided band-centric device under test, DUT, connector configuration is processed by a processor to derive automatically a connection diagram CDIA for performing cabling between the test device 2 and the device under test 3.

In step S2 a connection diagram CDIA is derived in a possible embodiment automatically by a specific optimization algorithm (such as MILP) according to optimization criteria on the basis of information stored in an information database INF-BASE as illustrated schematically in the embodiment of FIG. 5. In a further step S3 of the method shown in the flow chart of FIG. 2 the derived connection diagram CDIA and/or a machine readable connection list is output via an interface of the test system 1. The interface can comprise a graphical user interface GUI of the test device 2 or an interface of another terminal if the test system 1. The interface can also comprise a control and data interface used to transfer a calculated connection data set and/or a machine readable connection cabling list to an external controller or control unit of an automation system.

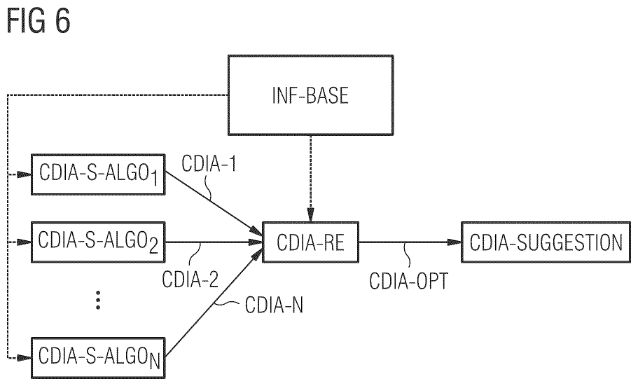

In a preferred embodiment of the method according to the present invention as illustrated in the flow chart of FIG. 2 in step S2 multiple connection diagrams CDIAs are provided by a number N of implemented optimization algorithms (CDIA-suggestion algorithms) from which an optimal connection diagram CDIA-opt is selected by a Connection Diagram Rating Engine CDIA-RE as illustrated in the embodiment of FIG. 6. The Connection Diagram Rating Engine CDIA-RE is adapted to calculate in step S2 a rating according to a predefined metric for each received connection diagram CDIA on the basis of the information stored in the information database INF-BASE and is adapted to select subsequently the connection diagram CDIA having the highest calculated rating as the optimal connection diagram CDIA-opt. The optimal connection diagram CDIA-opt is then output in step S3 via an interface of the test system 1 as the suggested connection diagram CDIA-SUGGESTION as also illustrated in FIG. 6.

In a possible embodiment of the method for providing a connection diagram CDIA between a test device 2 and a device under test 3 according the characteristics of the connectors of the test device 2 comprise specific frequency bands FBs, power levels, power ranges and data transfer directions (RX/TX).

The connection diagram CDIA can be calculated automatically by an agent to fulfill predefined optimization criteria. The connection diagram CDIA and/or connection list is calculated in a possible embodiment by an optimization algorithm run by the agent to determine an optimum cabling between the test device 2 and the device under test 3 providing a high number of test scenarios and minimizing the likelihood for requiring a re-cabling.

In a possible embodiment of the method for providing a connection diagram CDIA between a test device 2 and a device under test 3 the optimization algorithm run by the agent comprises a mixed integer linear program (MILP) as illustrated in FIG. 5. The mixed integer linear program (MILP) can take into account a cell combination list comprising cells with frequency bands to be tested for determining the optimum cabling between the test device 2 and the device under test 3. In a possible embodiment of the method the mixed integer linear program (MILP) takes also into account a maximum use of hardware within the test device and/or splitters and combiners provided outside the test device 2 as optimization criteria for determining the optimum cabling between the test device 2 and the device under test 3.

In a further possible embodiment of the method for providing a connection diagram between a test device 2 and a device under test 3 the connection diagram CDIA and/or connection list is calculated by the agent on the basis of a trained data model. In a possible embodiment the data model of the agent is trained by reinforcement learning (RL). The data model can comprise a deep learning model, in particular a trained artificial neural network (ANN), trained in a training phase on the basis of training data. In a preferred embodiment reinforcement learning (RL) is applied since no labeled data is required and the agent can learn in a simulated environment. In an alternative embodiment training of the machine learning model is performed on the basis of labeled data. A plurality of data can be generated by simulation. This can be extended for splitters and combiners by online re-training on the target system. A connector centric DUT connector configuration can be used too and can be transformed to a frequency band-centric representation.

A goal is to find a connection diagram CDIA and/or a cabling for the DUT (e.g. mobile phone) 3 for which a customer can test network deployments for whatever test purposes with a minimal likelihood that an unwanted cumbersome re-cabling becomes necessary.

A frequency Band-Centric DUT Connector configuration as shown in the example of FIG. 4 provides a mapping between frequency bands FBs and a set of DUT connectors/antennas in TX/RX direction. For instance a frequency band FB1 is mapped to a Connector in TX and RX direction and to a connector in RX direction. This information can be used later in order to route signals of emulated cells parametrized with frequency band FB1 to the right DUT connectors via the existing connections.

An optimization algorithm such as a mixed linear integer programming (MILP) algorithm with the target to maximize the amount of hardware used can be used to solve this problem. This works with or without given splitters and combiners.

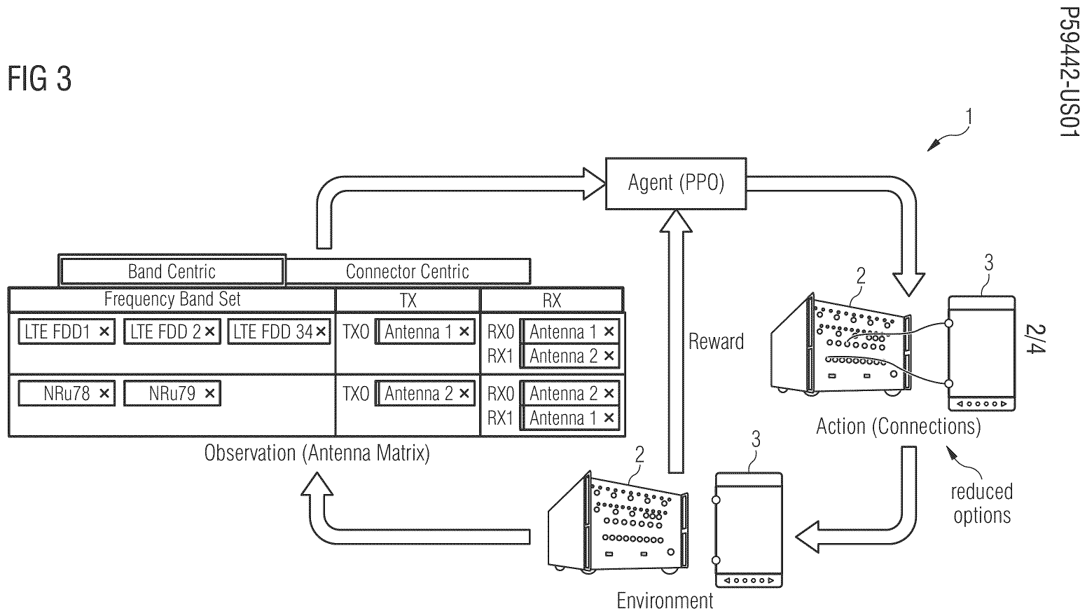

For the embodiment where reinforcement learning (RL) is applied, a data model or agent must first be trained. To do this actions are defined. In this case the creation of a connection diagram CDIA and/or connection list is defined as the action to be performed by the agent. Further, the input to the agent is also defined. In his case the antenna configurations in the band-centric view can form the input to the agent as illustrated in FIG. 3.

A number of DUT antenna configurations are collected for training. First, the agent starts with random actions, i.e. with random connections. Depending on the connections, the agent is rewarded as illustrated in FIG. 3. If the connections allow many test scenarios to be carried out, the agent receives a high reward. The internal model is adapted based on the rewards, i.e. similar connection diagrams are more likely with high rewards. After longer training, the agent will be able to create connection diagrams CDIA that yield more rewards. The training of the data model or agent takes place in a preferred embodiment with different DUTs and can generalize to new DUTs as long as these DUTs are not very different from DUTs in the training data.

In alternative embodiments other algorithms, such as deep learning, can also be used. For this, data is first collected. For example, pairs of antenna configurations and connection diagrams can be collected. These pairs are then assigned a label that indicates how good the connection diagram CDIA is. To collect the data, DUTs 3 and connection diagrams CDIAs /d/ connection lists can be randomly tested on simulations. A deep learning model can then be trained, which predicts the quality for such a pair. When using such a deep learning model, different connection diagrams CDIAs can then be quickly evaluated for a DUT 3. The connection diagram CDIA and/or connection list with the highest predicted quality forms then the result.

In a further alternative embodiment instead of the application of Machine Learning (ML) approaches, an optimization approach can be applied. The optimization approach as illustrated in the embodiment of FIG. 5 defines rules for what constitutes a good connection diagram CDIA. The optimization criteria can include, for example, how much hardware is used. Furthermore, the antenna configuration in band-centric view and the underlying test system hardware play a role. The optimization problem can be described as a mixed integer linear program (MILP) and can thus be solved by open-source solvers. A Mixed Integer Linear Program (MILP) algorithm is an optimization technique used to find the best solution to a problem modelled by linear relationships, where some variables are constrained to be integers. Evaluation of an RL approach and an MILP approach as concepts has demonstrated that both approaches provide good results and are able to create connection diagrams that allow a large number of test scenarios.

A target of the method illustrated in the flow chart of FIG. 2 is to find a connection diagram CDIA and/or a cabling list for a device under test 3 such as a mobile phone for which a customer can test network deployments whatever he wants test with a minimal likelihood that a cumbersome re-cabling is required. The connection diagram CDIA and/or connection list calculated in step S2 of the method shown in the flow chart of FIG. 2 indicates a cabling that minimizes the need for re-cabling. When performing several different tests on one device under test (DUT) 3 and/or when performing tests on one device under test DUT 3 after the other the cabling of the test device 2 can be kept and only the device under test DUT 3 requires re-cabling. This can be achieved with little effort.

In a possible embodiment of the method according to the present invention a machine learning model, trained for example by reinforcement learning (RL), is adapted to derive a connection diagram CDIA and/or connection list by using the provided frequency band-centric connector configuration of the device under test 3. The machine learning model can be trained using one or multiple simulations or real hardware setups such as mobile radio tester.

The mobile radio tester or test device 2 of the test system 1 is applicable for testing a user equipment (UE) from different aspects, i.e. RF, Protocol, IP services etc., including the data throughput testing. It forms a test platform to fulfill the measurement requirements in which the test devices 2 of the test system 1 can emulate various test scenarios with configurable network parameters.

To route the signal from the test device 2 to the right DUT antenna port, and vice versa, mapping information of DUT's supported band and its associated antenna port needs to be kept and the physical cabling between the DUT's antenna port and RF port of the test device 2 can configured as a preliminary requirement on the test device 2 before starting the network emulation.

The hardware and software of the test system 1 is designed to address all signaling use cases that are encountered during the lifecycle of a 5G NR mobile communications device - from the early design stage to final integration, verification/performance testing, final product validation, quality assurance and repair. The test system 1 is provided to cover all test requirements that may come up during the entire product lifecycle of a mobile communications device 3. The many components of a mobile communications device need to be independently tested on various interfaces step by step - in development, during integration when components need to work together, and in the final device.

The test system 1 as illustrated schematically in FIG. 1 can support a wide range of technologies, including 5G NR, LTE, and previous generations. It is designed to perform extensive testing of mobile devices, including signaling, RF, and end-to-end data performance. The test system 1 provides multi-standard support. It supports various mobile communication standards such as 5G NR (both NSA and SA), LTE, LTE-A, WCDMA, and more. The test system 1 is capable of testing multiple radio access technologies (RATs) concurrently.

The test system 1 provides signaling and protocol testing. The test system 1 can performs comprehensive signaling and protocol testing for different standards. It is able to perform testing of different network scenarios, including handovers, carrier aggregation, and dual connectivity. The test system 1 is adapted to simulate network conditions to test device behavior of the device under test 3 under various test scenarios.

The test system 1 is adapted to perform RF Testing. The test system 1 can conduct RF parametric testing to ensure the device meets regulatory and performance standards. The test system 1 is adapted to measures parameters such as output power, sensitivity, spurious emissions, and more. The test system 1 can further be adapted to support over-the-air (OTA) testing using anechoic chambers or radiated test environments.

The test system 1 is further adapted to perform End-to-End Data Testing. The test system 1 is adapted to evaluate data performance by simulating real-world data traffic and measuring throughput, latency, and quality of service (QoS). The test system 1 can further be adapted supports testing of voice, video, and data services over the mobile network.

A modular design of the test system 1 allows for easy upgrades and scalability to meet future testing needs. The test device 2 of the test system 1 can be configured with multiple hardware and software options to tailor the test system 1 to specific testing requirements.

After having derived the connection diagram and/or connection list the test device 2 of the test system 1 can be set up by connecting it to the device under test 3 through appropriate interfaces (e.g., coaxial cables for RF testing, network interfaces for protocol testing) according to the derived connection diagram or connection list. The derived connection diagram and/or connection list can be displayed on a display unit of a graphical user interface (GUI) of the test device 2 to a user.

The test system 1 can be further configured by a user through the graphical user interface (GUI) of the test device 2 and/or according to automation scripts to define the test scenarios, parameters, and measurement criteria.

For example a 5G NR DUT 3 can be connected to the test device 2 of the test system 1. The test system 1 is then configured to simulate a 5G NR base station and core network. Further specific test scenarios can be defined or configured, such as initial access, handover to LTE, and carrier aggregation.

After the cabling and further configuration steps have been completed the execution of tests is performed by the test device 2 of the test system 1. These tests can include signaling tests, RF test and data tests,

During signaling tests the test system 1 can simulate network elements (e.g., base stations, core network) to create a controlled test environment. The test system 1 initiates and manages signaling procedures such as registration, call setup, data sessions, handovers, and more. Protocol analyzers capture and decode signaling messages for analysis. For example signaling tests are performed to ensure the DUT 3 correctly registers with the 5G NR network, establishes a data session, and maintains connectivity.

When performing RF Tests the test system 1 generates and receives RF signals to and from the device under test 3. The test system 1 performs measurements on the transmitted and received signals to assess RF performance. Results can be compared against standard specifications to determine compliance. For example RF tests are conducted to measure the DUT's transmitter power, EVM (Error Vector Magnitude), and receiver sensitivity.

For performing data tests the test system 1 generates data traffic (e.g., IP packets) and sends it to the device under test 3. The test system 1 can measure key performance indicators (KPIs) such as data rates, latency, packet loss, and jitter. End-to-end application tests, such as video streaming and web browsing, can be performed as well to evaluate user experience. For example data tests can be executed to measure the downlink and uplink throughput, latency, and QoS for various applications.

Test results of the various tests can be collected and analyzed using built-in analysis tools of the test system 1. Detailed reports can be generated to document the test outcomes, including pass/fail status, measured values, and any detected issues. Results can be used for troubleshooting, performance optimization, and certification purposes.

Cabling of the connectors is performed according to the calculated connection diagram and/or connection list. The connection diagram can identify the DUT Connectors. It can indicate the RF connectors on the device under test DUT 3. These can include antenna ports, test points, or specific connectors designed for testing purposes. The connection diagram CDIA further indicates the test device connectors. These connectors can be labeled and can be designed to interface with standard RF connectors.

An RF output port of the test device 2 can be connected to the RF input port of the DUT 3 for transmission tests. An RF output port of the DUT 3 can be connected to the RF input port of the test device 2 for reception tests.

If the test requires control or data communication, the necessary control and data cables (e.g., USB, Ethernet) are connected between the DUT 3 and the test device 2 of the test system 1. It is ensured that the DUT 3 is powered appropriately, either through its internal battery or an external power supply connected via suitable cables.

Proper cabling of connectors for the DUT 3 and the test device 2 of the test system 1 is crucial for accurate and reliable testing. Calculation a connection diagram and/or connection list for cabling a device under test (DUT) 3 to a test device 2 of a mobile radio test system 1 involves detailing the connections between the DUT 3 and the test system's various interfaces.

The test device 2 of the test system 1 can include RF Ports for transmitting and receiving RF signals, control Interfaces for controlling the DUT 3 (e.g., USB, Ethernet) and data interfaces for data communication (e.g., Ethernet). The device under test (DUT) 3 can comprise antenna Ports used for RF signal input and output, control ports for device control (e.g., USB) and data ports used for data transmission (e.g., Ethernet).

For the embodiment using reinforcement learning (RL), a model/agent must first be trained. This requires to define actions, i.e. in this case the creation of a connection diagram. Actions are performed by the reinforcement learning (RL) agent. Finally, the input to the agent must also be defined. In this case, the input comprises the antenna configurations in the so-called band-centric view.

For training, a number of DUT antenna configurations can be collected. First, an agent starts with random actions, i.e. with random connections. Depending on the connections, the agent is rewarded. If the connections allow many test scenarios to be carried out, the agent can be carried out with it and the agent receives a high reward. The internal data model is adjusted based on the rewards, i.e. for high rewards, similar connection diagrams become more likely. After longer training, the agent will be able to create connection diagrams that yield more rewards. Training takes place in a preferred embodiment with different devices under test, DUTs, and can therefore also generalize to new DUTs as long as the devices under test DUTs are not very different from devices under test DUTs used to provide the training data.

Other algorithms, such as deep learning, can also be used. For this, data must first be collected. For example, pairs of antenna configurations and connection diagrams can be collected. A label is then assigned to these pairs, which indicates how good the respective connection diagram CDIA is. To collect the required data devices under test DUTs 3 and connection diagrams CDIAs can be randomly tested on simulations. A deep learning model can then be trained to predict the quality of such a pair. When using such a data model, different connection diagrams CDIA can then be quickly evaluated for a device under test DUT 3. The connection diagram CDIA one with the highest predicted quality forms then the result.

In addition to applying machine learning (ML) approaches an Optimization approach can be included. The optimization approach defines rules for what constitutes a good connection diagram CDIA. Optimization criteria can include for example how much hardware is used. The optimization criteria can be stored in the information database INF-BASE shown in the embodiments of FIG. 5 and FIG. 6. Furthermore, the antenna configuration in the Band-Centric View and the underlying test system hardware of the test system 1 can also play a role. The optimization problem can be described as a Mixed Integer Linear Program MILP and can therefore be solved by open-source solvers.

The reinforcement learning (RL) approach and the Mixed Integer Linear Program (MILP) approach show both good results and are able to create connection diagrams CDIA that allow a large number of test scenarios. The Mixed Integer Linear Program (MILP) approach does even show better results than the reinforcement learning (RL) approach.

Previously a user had to perform cabling manually based on a learnt system behavior. In a possible embodiment of the test method and the test system 1 according to the present invention a user gets a connection diagram suggestion CDIA-SUGGESTION based on a single hardcoded algorithm. However, such a hardcoded algorithm needs to be extended for every new device under test (DUT) type. Further a connection optimizer based on a rule based algorithm can be used.

In a possible embodiment a connection diagram CDIA can be selected given a single optimization algorithm on the basis of optimization criteria as illustrated for example in FIG. 5, where the used optimization algorithm comprises an MILP optimization algorithm. However, evaluations show that some optimization algorithms outperform others in certain conditions.

Therefore in a preferred embodiment of the test method and the test system 1 according to the present invention a connection diagram rating engine CDIA-RE is added as illustrated in FIG. 6. The use of a Connection Diagram Rating Engine CDIA-RE allows to select among the output of different algorithms the optimal result for any given situation. The test method and test system 1 according to the present invention does not rely on specific algorithms and is extendable for any new algorithms.

The Connection Diagram Rating Engine CDIA-RE of the test system 1 as shown in FIG. 6 is adapted to select an optimal Connection Diagram CDIA from the output of multiple Connection Diagram Suggestion Algorithms CDIA-S-ALG as illustrated schematically in FIG. 6. As can be seen the Connection Diagram Rating Engine CDIA-RE gets a number N of Connection Diagrams CDIA-1, CDIA-2 . . . to CDIA-N from different implemented Connection Diagram Suggestion Algorithms CDIA-S-ALG. The Connection Diagram Suggestion Algorithms CDIA-S-ALG comprise different kinds of optimization algorithms including for instance a Mixed Integer Linear Program (MILP) algorithm, a reinforcement learning (RL) algorithm or a rule based optimization algorithm. The number N of implemented Connection Diagram Suggestion Algorithms CDIA-S-ALG can vary for different use cases.

The Connection Diagram Suggestion Algorithms CDIA-S-ALG can be executed on the same or different processors of the test system 1. In a preferred embodiment the various Connection Diagram Suggestion Algorithms CDIA-S-ALG are run in parallel on different processors or processor cores to enhance the performance of the test system 1.

Multiple different types of optimization algorithms based on reinforcement learning (RL)/machine learning (ML) and on mathematical optimization can be applied. In a possible embodiment of the present invention a list of optimization algorithms of any type is provided to derive an optimal connection diagram CDIA-Opt. The Connection Diagram Rating Engine CDIA-RE of the test system 1 receives a number N of Connection Diagram CDIAs from the Connection Diagram Suggestion Algorithms CDIA-S-ALGs and calculates a rating with respect to the quality of the received Connection Diagram CDIAs taking into account information stored in an information database INF-BASE of the test system 1 as illustrated in FIG. 6. The information database INF-BASE can store information about the external hardware (Splitter, Combiner, Switch Units), the test instrument hardware, the DUT profile/hardware and test plan (Cell deployments) and other relevant information. The Connection Diagram CDIA having the highest calculated rating is automatically selected by the Connection Diagram Rating Engine CDIA-RE as the optimal Connection Diagram CDIA-opt and then output as a connection diagram suggestion CDIA-SUGGESTION via an interface of the test system 1.

The information database INF-BASE of the test system 1 can be implemented in a possible embodiment in a memory of the test device 2 illustrated in FIG. 1. The information database INF-BASE of the test system 1 can be implemented in a further possible embodiment in a remote database or cloud to which the processor 2A of the test device 2 has access via a data network. The data content of the information database INF-BASE can be updated depending on the type of the device under test 3 and/or the available test equipment.

In a preferred embodiment of the test system 1 Connection Diagram Rating Engine CDIA-RE is added as illustrated schematically in FIG. 6. The Connection Diagram Rating Engine CDIA-RE of the embodiment of the test system 1 shown in FIG. 6 is able to rate how good a connection diagram CDIA is based on the information stored in the information database INF-BASE, in particular how good a proposed connection diagram CDIA calculated by a CDIA-suggestion algorithm is
for a given device und test
for a given test instrument
for a given set of external combiners/splitters or switch units (external hardware)
potentially for a given list of cell deployments that should be tested with the above items and/or
based other relevant information stored in the information database INF-BASE

The Connection Diagram Rating Engine CDIA-RE as shown schematically in FIG. 6 can comprise in different embodiments:
a real test instrument
a simulation of a real test instrument
a prediction engine
an artificial neural network (ANN) predicting a rating
a state-of-art LLM (e.g. fine-tuned on connection diagram rating applications)
any other rating engine

In a possible embodiment of the test system 1 a number of suitable Connection Diagram Suggestion Algorithms CDIA-S-ALGs can be selected from all available Connection Diagram Suggestion Algorithms CDIA-S-ALGs depending on the type of the device und test 3 and/or depending on the available test hardware and/or depending on a user selection command. Further, the applied optimization criteria can be selected depending on the type of the device und test 3 and/or depending on the available test hardware and/or depending on a user selection command.

Although the disclosure has been illustrated and described with respect to one or more implementations, equivalent alterations and modifications will occur to others skilled in the art upon the reading and understanding of this specification and the annexed drawings. In addition, while a particular feature of this disclosure may have been disclosed with respect to only one of several implementations, such feature may be combined with one or more other features of the other implementations as may be desired and advantageous for any given or particular application.

1. A method for providing a connection diagram between a test device and a device under test, DUT, wherein said test device has a plurality of connectors with different characteristics and said device under test has a plurality of antennas, wherein the connection diagram is calculated automatically on the basis of a Band-Centric DUT Connector Configuration indicating a mapping between frequency bands and a set of DUT connectors and/or antennas in transmission direction and reception direction.

2. The method for providing a connection diagram between a test device and a device under test according to claim 1 comprising the steps of:
providing a band-centric device under test, DUT, connector configuration of the device under test;
processing the provided band-centric device under test, DUT, connector configuration to derive at least one connection diagram and/or at least one connection list between the test device and the device under test, DUT; and
outputting the derived connection diagram and/or connection list via an interface.

3. The method for providing a connection diagram between a test device and a device under test according to claim 1, wherein the characteristics of the connectors of the test device comprise specific frequency bands, power levels, power ranges and data transfer directions.

4. The method for providing a connection diagram between a test device and a device under test according to claim 2, wherein the connection diagram and/or connection list is calculated automatically by an agent to fulfill predefined optimization criteria.

5. The method for providing a connection diagram between a test device and a device under test according to claim 2, wherein a single connection diagram and/or connection list is calculated by an optimization algorithm run by an agent to determine an optimum cabling between the test device and the device under test, DUT, providing a high number of test scenarios and minimizing the likelihood for requiring a re-cabling or wherein multiple connection diagrams and/or connection lists are calculated by different optimization algorithms run by agents and supplied to a connection diagram rating engine which selects automatically an optimal connection diagram having a highest calculated rating based on information stored in an information database.

6. The method for providing a connection diagram between a test device and a device under test according to claim 5, wherein the optimization algorithm run by the agent comprises a mixed integer linear program (MILP).

7. The method for providing a connection diagram between a test device and a device under test according to claim 6, wherein the mixed integer linear program (MILP) takes into account a cell combination list comprising cells with frequency bands to be tested for determining the optimum cabling between the test device and the device under test.

8. The method for providing a connection diagram between a test device and a device under test according to claim 7, wherein the mixed integer linear program (MILP) takes into account a maximum use of hardware within the test device and/or splitters and combiners provided outside the test device as optimization criteria for determining the optimum cabling between the test device and the device under test.

9. The method for providing a connection diagram between a test device and a device under test according to claim 5, wherein the connection diagram and/or connection list is calculated by the agent on the basis of a trained data model.

10. The method for providing a connection diagram between a test device and a device under test according to claim 9, wherein the data model of the agent is trained by reinforcement learning.

11. The method for providing a connection diagram between a test device and a device under test according to claim 10, wherein the data model comprises a deep learning model trained in a training phase on the basis of training data.

12. A test system for providing a connection diagram between a test device of said test system and a device under test, DUT, wherein said test device has a plurality of connectors with different characteristics and said device under test, DUT, has a plurality of antennas, wherein the connection diagram is calculated by a processor of the test system automatically on the basis of a given Band-Centric DUT Connector Configuration indicating a mapping between frequency bands and a set of DUT connectors and/or antennas in transmission direction and reception direction.

13. The test system for providing a connection diagram between a test device of said test system and a device under test according to claim 12 comprising:
a memory adapted to store a band-centric device under test, DUT, connector configuration of a device under test, DUT;
a processor adapted to process the band-centric device under test, DUT, connector configuration of the device under test, DUT, to derive at least one connection diagram and/or at least one connection list between the test device and the device under test, DUT; and
an interface adapted to output the connection diagram and/or connection list derived by the processor.

14. The test system for providing a connection diagram between a test device of said test system and a device under test according to claim 12, wherein the processor is adapted to calculate a single connection diagram and/or a single connection list by means of a specific optimization algorithm run by an agent to determine an optimum cabling between the test device and the device under test, DUT, providing a high number of test scenarios and minimizing the likelihood for requiring a re-cabling.

15. The test system for providing a connection diagram between a test device of said test system and a device under test according to claim 12, wherein the processor is adapted to calculate multiple connection diagrams and/or connection lists by means of different optimization algorithms run by agents and supplied to a connection diagram rating engine of the test system which is configured to select automatically an optimal connection diagram having a highest calculated rating based on information stored in an information database.

16. The test system for providing a connection diagram between a test device of said test system and a device under test according to claim 14, wherein the single calculated connection diagram or the connection diagram selected by the connection diagram rating engine is output via an interface of the test system as a cabling suggestion.

17. The test system for providing a connection diagram between a test device of said test system and a device under test, DUT, according to claim 12, wherein test device interfaces of the test device and device under test interfaces of the device under test, DUT, are connectable with each other by means of cables according to the calculated connection diagram.

18. The test system for providing a connection diagram between a test device of said test system and a device under test, DUT, according to claim 15, wherein the test device of the test system comprises test device interfaces including RF Ports used for transmitting and receiving RF signals, control interfaces used for controlling the device under test, DUT, and data interfaces provided for data communication with the device under test, DUT.

19. The test system for providing a connection diagram between a test device of said test system and a device under test, DUT, according to claim 15 wherein the device under test, DUT, comprises device under test, DUT, interfaces including antenna ports for RF signal input and RF signal output, control ports and data ports for data communication with the test device.

20. The test system a for providing a connection diagram between a test device of said test system and a device under test, DUT, according to claim 12, wherein the calculated connection diagram indicates a cabling that minimizes the need for re-cabling when performing several different tests on a single device under test, DUT, and/or when performing several different tests sequentially on several devices under test, DUTs, of a group of devices under test, DUT, one device under test, DUT, after the other.

21. The test system for providing a connection diagram between a test device of said test system and a device under test according to claim 12, wherein the device under test, DUT, comprises a user equipment, UE, in particular a mobile phone.

22. A software tool for providing a connection diagram between a test device and a device under test, wherein said test device has a plurality of connectors with different characteristics and said device under test, DUT, has a plurality of antennas, wherein the software tool is adapted to calculate automatically the connection diagram and/or a connection list on the basis of a Band-Centric-DUT-connector configuration indicating a mapping between frequency bands and a set of DUT connectors and/or antennas in a transmission direction and a reception direction.
